(19) United States
(12) Patent Application Publication
(10) Pub. No.: US 2009/0153307 A1
(43) Pub. Date: Jun. 18, 2009

(54) POSITION MEASUREMENT TERMINAL AND METHOD USING LOCATIONS OF POSITION IDENTIFYING TAGS

(75) Inventors: Jaeho KIM, Daejeon-city (KR); Gyungchul Sihn, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/207,952

(22) Filed: Sep. 10, 2008

(30) Foreign Application Priority Data
Dec. 17, 2007 (KR) 10-2007-0131957

(51) Int. Cl. H04Q 5/22

(52) U.S. Cl. 340/10.41

(57) ABSTRACT

A position measurement terminal using locations of position identifying tags includes a photographing unit that photographs one of a plurality of position identifying tags including tag identifying information and processes an image of the photographed position identifying tag; a control and operation unit that performs a control and operation for location measurement of the position measurement terminal; and a communication unit that has access to a tag position information server that stores position information corresponding to tag identifying information of the individual position identifying tags and receives position information of the photographed position identifying tag.

### BACKGROUND OF THE INVENTION

1. Field of the Invention

The present invention relates to a position measurement terminal and method, and more particularly, to a position measurement terminal and method that can recognize a current location of a user using locations of the position identifying tags obtained by photographing position identifying tags.

This work was supported by the IT R&D program of MIC/IITA [2006-S-003-02, Research on Service Platform for the Next Generation Mobile Communication].

2. Description of the Related Art

Various methods that allow a user to recognize a current location using a portable terminal have already been studied, and methods that provide various services to the user using a recognized location have been continuously studied.

A current user location recognition method may be classified into a method based on a network and a method based on a handset. The method based on the network measures a time difference between signals received from a mobile communication base station and calculates a location of a user having a portable terminal on the basis of a measured value. The method based on a handset receives a GPS signal or a network signal using the handset or receives the GPS signal and the network signal and combines the two signals, and calculates a current location of a user using the handset.

Existing position recognition systems based on a GPS or mobile communication network can be effectively used outdoors, but cannot be effectively used indoors or in the underground or shady regions of buildings due to low precision, signal attenuation, and a multi path. In order to solve this problem, various researches are being performed. Indoor position recognition systems that use ultraviolet rays, ultrasonic waves, and radio frequencies have been developed. However, in the existing indoor position recognition systems, an apparatus that is capable of transmitting and receiving ultraviolet rays, ultrasonic waves, and radio frequencies should be additionally disposed in an indoor physical space, and a portable terminal of a user should also have this function. Accordingly, in order to use the existing indoor position recognition systems, a large amount of costs are required and a precise apparatus needs to be additionally provided.

### SUMMARY OF THE INVENTION

Accordingly, the invention has been made to solve the problems in the related art, and it is an object of the invention to provide a position measurement terminal and method that can recognize a location of a user using a camera basically installed in a portable terminal of the user and without providing an additional apparatus in a specific physical space, such as indoors.

According to an aspect of the invention, there is provided a position measurement terminal using locations of position identifying tags. The position measurement terminal includes a photographing unit that photographs one of a plurality of position identifying tags including tag identifying information and processes an image of the photographed position identifying tag; a control and operation unit that performs a control and operation for location measurement of the position measurement terminal; and a communication unit that has access to a tag position information server that stores position information corresponding to tag identifying information of the individual position identifying tags and receives position information of the photographed position identifying tag.

The position measurement terminal according to the aspect of the invention may further include a position information storage unit that stores the position information corresponding to the tag identifying information of the individual position identifying tags. The control and operation unit may extract the position information of the photographed position identifying tag from the position information storage unit. The control and operation unit may extract tag identifying information from the image of the photographed position identifying tag and transmit the extracted tag identifying information to the tag position information server through the communication unit.

The control and operation unit may calculate the location of the position measurement terminal on the basis of the position information of the position identifying tag, a photographing distance of the position identifying tag, and a photographing angle of the position identifying tag. The position measurement terminal according to the aspect of the invention may further include a direction measuring unit that calculates the photographing angle of the position identifying tag.

The position measurement terminal according to the aspect of the invention may further include a movement distance measuring unit that measures a movement distance of the position measurement terminal; and a direction measuring unit that measures a movement direction of the position measurement terminal. The control and operation unit may trace the location of the position measurement terminal on the basis of the position information of the position identifying tag, information on a movement distance measured by the movement distance measuring unit, and information on a movement direction measured by the direction measuring unit. The movement distance measuring unit may be a pedometer that measures the number of steps of a user.

When a new position identifying tag is photographed and new position information is obtained, the traced location of the position measurement terminal may be updated. The control and operation unit may update an average footstep value for each movement speed through learning using actually measured data.

According to another aspect of the invention, there is provided a position measurement method using locations of position identifying tags. The position measurement method includes allowing a photographing unit to photograph one of a plurality of position identifying tags including tag identifying information; allowing a control and operation unit to extract the tag identifying information from the photographed position identifying tag; and having access to a tag position information server that stores position information corresponding to the tag identifying information to acquire the position information corresponding to the extracted tag identifying information.

The position measurement method according to another aspect of the invention may further include calculating the location of the position measurement terminal on the basis of the acquired position information in the acquiring of the position information, a photographing distance of the position identifying tag, and a photographing angle of the position identifying tag. The position measurement method according to another aspect of the invention may further include tracing the location of the position measurement terminal on the basis of the acquired position information in the acquiring of the position information, information on a movement distance measured by a movement distance measuring unit, and information on a movement direction measured by a direction measuring unit.

The position measurement method according to another aspect of the invention may further include, when position information of a new position identifying tag is acquired in the acquiring of the position information, updating the traced location of the position measurement terminal in the tracing of the location. The position measurement method according to another aspect of the invention may further include updating an average footstep value for each movement speed through learning using actually measured data. The movement distance measuring unit may be a pedometer that measures the number of steps.

According to the position measurement terminal and method using the locations of the position identifying tags according to the invention, it is possible to use low-priced position identifying tags that can be printed on general paper. A position measurement system can be constructed at a low cost by using a camera that is basically mounted in a portable terminal of a user, such as a mobile phone, a PDA, and a laptop computer, without requiring a separate apparatus.

Accordingly, as compared with a position measurement system according to the related art for position measurement indoors, and a system construction cost decreases, position measurement can be easily made using a portable terminal of a user. Thus, the possibility of applying services increases and a relatively accurate position measurement result can be provided.

Further, if a position measurement terminal according to the invention is mounted in a self-controlled mobile robot, it is possible to easily recognize a current location of the robot.

### BRIEF DESCRIPTION OF THE DRAWINGS

FIG. 1 is a diagram illustrating a method in which a user measures a location on the basis of a visually recognized image, which is provided to better understand the invention;

FIG. 2 is a system layout diagram illustrating a position measurement system according to an embodiment of the invention;

FIG. 3 is a schematic block diagram illustrating a structure of a position measurement system according to an embodiment of the invention;

FIG. 4 is a diagram illustrating a principle of recognizing a current location of a user according to an embodiment of the invention; and

FIG. 5 is a flowchart illustrating a procedure of calculating a movement distance of a user using a pedometer that measures the number of steps in accordance with an embodiment of the invention.

### DESCRIPTION OF THE PREFERRED EMBODIMENTS

Hereinafter, the preferred embodiments of the invention will be described with reference to the accompanying drawings for better understanding of the invention. The embodiments that will be described below are provided for better understanding of the invention, and the invention is not limited thereto.

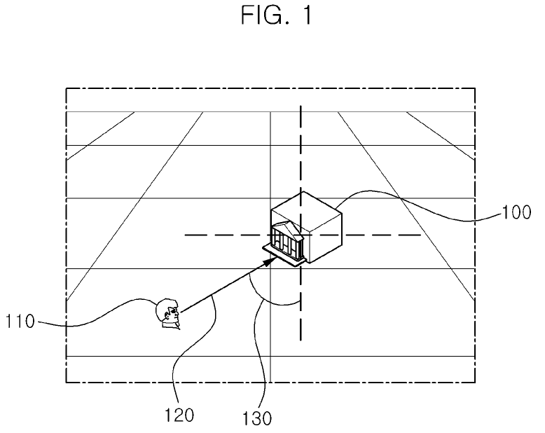

FIG. 1 is a diagram illustrating a method in which a user measures a location on the basis of a visually recognized image, which is provided to better understand the invention.

A user 110 visually recognizes a position reference object 100 in which the user already knows a location and a direction through prior learning and experience. The user who has visually recognized the position reference object 100 may estimate a distance 120 between the user and the visually recognized position reference object 100 using depth perception. The user may estimate his or her viewing direction 130 in consideration of a direction of his or her eyes viewing the position reference object 100. Since the user is aware of the location and direction of the position reference object 100, the user can recognize the current location and direction of the user on the basis of the estimated relative distance between the user and the position reference object 100 and the estimated viewing direction in respects to the position reference object 100. When the plurality of position reference objects 100 exist in the same direction of where the user is looking, the user can accurately recognize the current location and direction of the user.

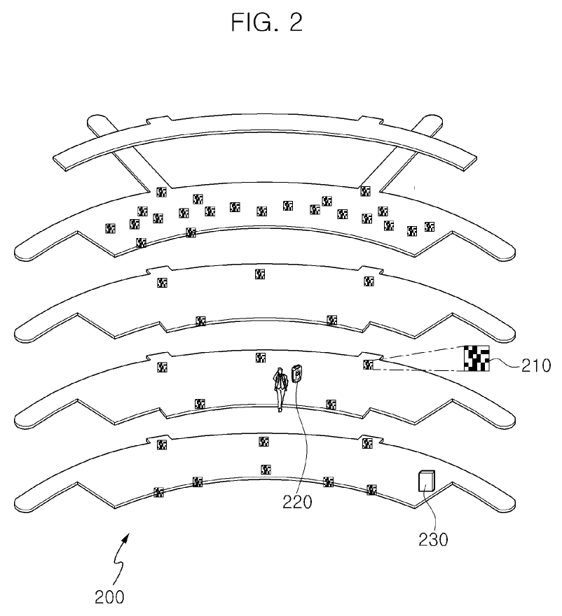

FIG. 2 is a system layout diagram illustrating a position measurement system according to an embodiment of the invention. FIG. 2 schematically shows an inner structure of a theater 200.

As exemplified in FIG. 2, in the position recognition system according to the embodiment of the invention, a plurality of position identifying tags 210 are disposed in a specific physical space, and a tag position information server 230 that stores locations of the position identifying tags 210 is disposed in the same physical space or at the outside of the physical space. The user can confirm a current location of the user using a portable terminal 220 that is a position measurement terminal.

In places such as the theater 200, it is generally difficult for a user to receive a GPS signal using a portable terminal and recognize a current location of the user. In particular, in the case where the theater 200 is located underground, it is not possible to recognize the current location of the user using the GPS signal. Meanwhile, in the related art, there is a method in which a current location is recognized by measuring relative movement distance and direction, when a GPS signal cannot be received. However, if the method according to the related art is used to recognize the current location of the user who does not move linearly like a vehicle, an error increases as the time elapses, which makes it impossible to obtain accurate position data. For this reason, in the method according to the related art, there are problems that should be technically resolved.

According to a basic structure in this invention, the plurality of position identifying tags 210 are disposed in the specific physical space 200, and position information of each of the position identifying tags 210 is stored in the tag position information server 230. In the drawings, for convenience, all the position identifying tags 210 are shown to have the same patterns. However, in actuality, each of the position identifying tags 210 has a different pattern shape, and each pattern shape includes tag identifying information of each position identifying tag 210.

When the user needs position information, the user photographs the position identifying tag 210 using a camera that is installed in the portable terminal 220, and transmits a photographed result to the tag position information server 230. In this case, the tag position information server 230 extracts position information of the position identifying tag 210 according to tag identifying information of the position identifying tag, and transmits the extracted information to the portable terminal 220. The position formation that the tag position information server 230 stores according to tag identifying information may be absolute coordinates, or physical position information of the specific physical space 200, for example, information such as row C, gate number 3, and the front of a ticket office, and include both the absolute coordinates and the physical position information. If the user receives and confirms the physical position information, this may be more practicable than if the user receives and confirms the absolute coordinates.

The position measurement terminal 220 can acquire the current location of the user on the basis of the transmitted location of the position identifying tag 210. After photographing the position identifying tag 210 and measuring the location, the position measurement terminal 220 may calculate the location of the user after movement on the basis of the movement distance and direction. Since the plurality of position identifying tags 210 are disposed, the position measurement terminal 220 photographs the position identifying tag 210 that is disposed at the location after movement and can update position information. Even though additional correction is not performed, it is possible to accurately obtain position information at all times.

The position identifying tags 210 are disposed at appropriate locations and with the appropriate density according to a characteristic of a specific physical space where the position identifying tags are to be disposed and desired precision of position recognition. Alternatively, the position identifying tags 210 may be disposed according to accessibility from the user. Since the position identifying tags 210 can be simply prepared by only printing patterns on mediums having surfaces, a position recognition system can be constructed at a low cost.

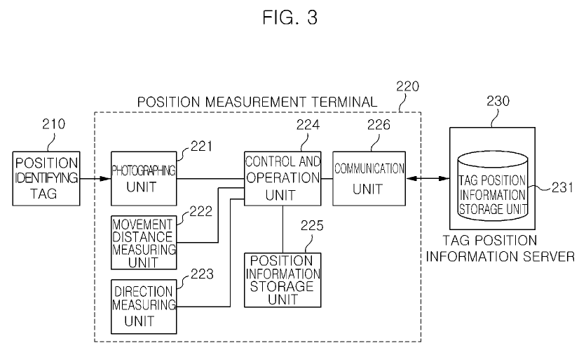

FIG. 3 is a schematic block diagram illustrating a structure of a position measurement system according to an embodiment of the invention. A position measurement system according to an embodiment of the invention includes a plurality of position identifying tags 210, a position measurement terminal 220, and a tag position information server 230.

The plurality of position identifying tags 210 are disposed in a specific physical space with different patterns, and each pattern shape includes tag identifying information of each position identifying tag. The position identifying tags 210 are provided to have appropriate sizes and colors, respectively, by printing pattern shapes on media having surfaces. Each of the position identifying tags 210 may directly represent information on a location at which each position identifying tag is attached. In the embodiment of the invention, it is assumed that the position identifying tags have tag identifying information that can discriminate the position identifying tags.

The position measurement terminal 220 that is a portable terminal of the user includes a photographing unit 221, a movement distance measuring unit 222, a direction measuring unit 223, a control and operation unit 224, a position information storage unit 225, and a communication unit 226. The tag position information server 230 includes a tag position information storage unit 231 to store position information corresponding to tag identifying information of each position identifying tag. Hereinafter, the structure of the position measurement terminal 220 will be described in detail.

The photographing unit 221 includes a camera that is installed in the portable terminal and an image processor that processes images photographed by the camera. When the user needs to measure a current location and the photographing unit 221 photographs the position identifying tag 210 disposed around the user, a photographed image is transmitted to the control and operation unit 224 that performs a control and operation in the position measurement terminal 220.

The control and operation unit 224 recognizes the corresponding position identifying tag 210 from the transmitted image, and extracts tag identifying information of the position identifying tag according to predetermined rules. The extracted tag identifying information is transmitted to the tag position information server 230 through the communication unit 226. Alternatively, the control and operation unit 224 may not extract the tag identifying information from the transmitted image but transmit the photographed image to the tag position information server 230, such that the tag position information server 230 may perform a process of extracting tag identifying information. In terms of performance of the position measurement terminal 220, it may be efficient for the tag position information server 230 having high performance to extract tag identifying information.

After receiving the tag identifying information or extracting the tag identifying information from the transmitted image of the position identifying tag, the tag position information server 230 extracts position information of the corresponding position identifying tag 210 from the tag position information storage unit 231. The tag position information storage unit 231 matches the tag identifying information with the position information and stores a matched result.

The tag position information server 230 transmits the extracted position information to the position measurement terminal 220, and the position measurement terminal 220 recognizes the location of the photographed position identifying tag 210. Meanwhile, in the above description, the position information of the position identifying tag 210 is obtained by inquiring the tag position information server 230. However, if the position information storage unit 225 that is included in the position measurement terminal 220 stores the position information of the corresponding position identifying tag 210, the position information of the position identifying tag 210 can be extracted by only inquiring the position information storage unit 225. The position information of all the position identifying tags 210 may be stored in the position information storage unit 225 that has a limited storage capacity, but more preferably, when the position measurement terminal enters the specific physical space, the position measurement terminal inquires the tag position information server 230 of the position information for the position identifying tag 210 of the specific physical space in advance, and may store the position information in the position information storage unit 225.

In the above-described example, only the position information of the position identifying tag 210 is obtained, but it is possible to recognize a current location of the user or the portable terminal using the relative location with the position identifying tag 210 that is photographed according to the principle described with reference to FIG. 1. That is, it is possible to recognize the current location of the user or portable terminal on the basis of current position information of the position identifying tag 210, a photographing distance, and a photographing angle.

For example, when it is assumed that the control and operation unit 224 knows information on an actual size of the position identifying tag 210, the control and operation unit 224 can calculate the distance from the position identifying tag 210 to the user on the basis of the size of the photographed image with reference to zoom-in/zoom-out information of the photographing unit 221. Further, it is possible to calculate a photographing direction of the position identifying tag 210 on the basis of an inclination of the image of the photographed position identifying tag 210 at left and right sides. It is possible to accurately calculate the current location of the user on the basis of the calculated distance between the user and the position identifying tag and the photographing direction of the position identifying tag. It is possible to acquire direction information of the position measurement terminal 220, that is, a photographing angle, using the direction measuring unit 223 installed in the position measurement terminal 220, which will be described below, without calculating the direction of the position identifying tag. In this case, it is possible to further accurately obtain the photographing angle.

The position measurement terminal 220 according to the embodiment of the invention includes the movement distance measuring unit 222 and the direction measuring unit 223. The movement distance measuring unit 222 measures the movement distance of the position measurement terminal 220. In this invention, as the movement distance measuring unit 222, a pedometer that measures the number of steps of the user is exemplified. In order to measure the number of steps, various methods may be used. For example, the number of steps is measured by a method using physical vibration or a method that measures a change pattern of acceleration using an acceleration sensor. In addition to the pedometer that measures the number of steps, various technologies may be applied to the movement distance measuring unit 222, even though there are differences in measurement accuracy or implementation costs.

The direction measuring unit 223 uses a geomagnetic sensor to measure the direction of the position measurement terminal 220. The direction measuring unit 223 can measure the movement direction of the user who possesses the position measurement terminal 220 using an acceleration sensor. In regards to the direction measuring unit 223 that measures the direction of the position measurement terminal 220 and the movement direction of the user, various technologies have been suggested in the related art, and may be applied to the invention.

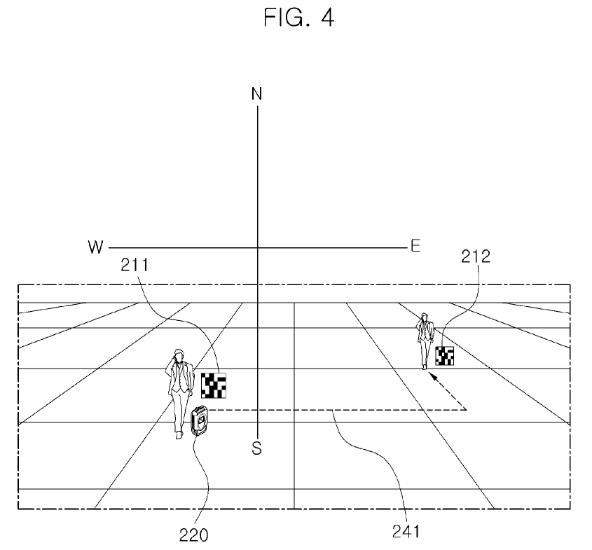

A method of tracing and recognizing the location of the user who possesses the position measurement terminal 220 using the movement distance measuring unit 222 and the direction measuring unit 223 according to the embodiment of the invention will be described with reference to FIG. 4. FIG. 4 is a diagram illustrating a principle of recognizing a current location of a user according to an embodiment of the invention.

After photographing a position identifying tag 211 and recognizing the current location, the user can move in the specific physical space. If the user moves, a movement path 241 can be recognized using the movement distance measuring unit 222 and the direction measuring unit 223 according to the embodiment of the invention. Accordingly, if the movement path 241 recognized by the movement distance measuring unit 222 and the direction measuring unit 223 is included in the position information obtained by photographing the position identifying tag 211, it is possible to acquire a current location of the user after movement. The process of acquiring the current location of the user is performed through an operation process of the control and operation unit 224.

That is, the control and operation unit 224 calculates the current location of the user or the position measurement terminal 220 on the basis of the previously obtained position information of the position identifying tag 210, the movement distance information received from the movement distance measuring unit 222, and the movement direction information received from the direction measuring unit 223. A portion or all of the above-described calculation process that is performed by the control and operation unit 224 may be performed by another server such as the tag position information server 230 according to a process capacity of the position measurement terminal 220, and the position measurement terminal 220 may receive only the calculated current location.

In FIG. 4, when the user moves and reaches another position identifying tag 212, the user can acquire new information on the current location of the user by photographing the corresponding position identifying tag 212, thereby updating current location information that is calculated along the movement path 241.

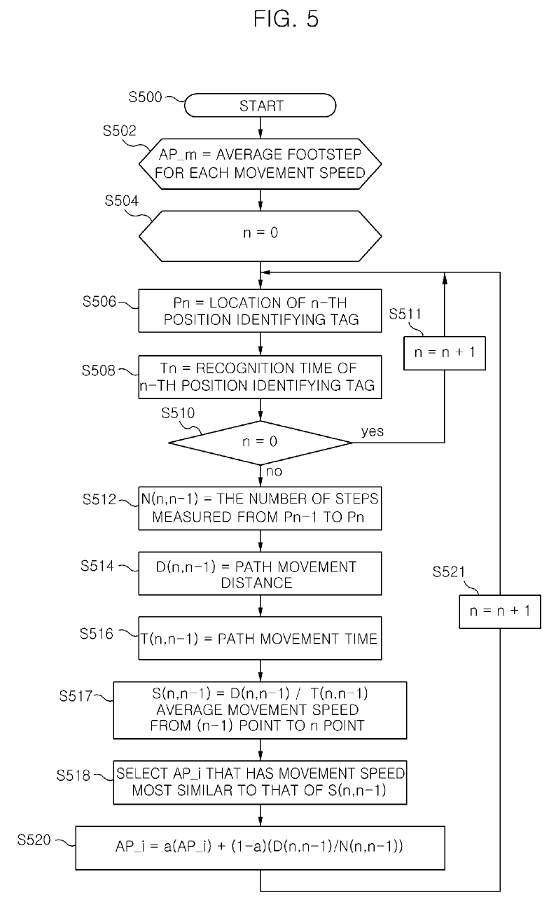

FIG. 5 is a flowchart illustrating a procedure of calculating a movement distance of a user using a pedometer that measures the number of steps in accordance with an embodiment of the invention. The procedure that will be described below is used to measure an accurate movement distance on the basis of the number of steps configured by using actually measured data in the case of using the pedometer as the movement distance measuring unit 222 according to the embodiment of the invention.

When the procedure starts in Step S500, an average footstep value for each movement speed is stored in advance in a variable of AP_m (m is an integer). That is, an average footstep value corresponding to each movement speed is stored. In Step S504, n is set as 0, and in Step S506, a location of an n-th position identifying tag is stored in a variable of Pn. In Step S508, a recognition time of the n-th position identifying tag is stored in a variable of Tn.

In Step S510, it is determined whether n=0 is satisfied. In the case where a position identifying tag is first recognized, since n=0 is satisfied, n is increased by 1 (Step S511), and the procedure returns to Step S506. In the case where a next position identifying tag is recognized, the location and the recognition time of the position identifying tag are respectively stored in the variables Pn and Tn, and the procedure proceeds to Step S512.

In Step S512, the number of steps that is measured by a pedometer from a point of time when the (n−1)-th position identifying tag is recognized to a point of time when the n-th position identifying tag is recognized is stored in a variable of N(n, n−1). In this case, N(n, n−1) indicates the number of steps in one interval. Then, in Step S514, a path movement distance from the (n−1)-th position identifying tag to the n-th position identifying tag is calculated and stored in a variable of D(n, n−1). In Step S516, a path movement time from the (n−1)-th position identifying tag to the n-th position identifying tag is calculated by referring to Tn−1 and Tn and stored in a variable of T(n, n−1).

Then, in Step S517, D(n, n−1) is divided by T(n, n−1) to calculate an average movement speed from the (n−1)-th position identifying tag to the n-th position identifying tag, and the average movement speed is stored in a variable of S(n, n−1). In Step S518, AP_i (i is an integer) that corresponds to a movement speed similar to that of S(n, n−1) is selected, and in Step S520, AP_i is learned. In the learning on AP_i, the already obtained D(n, n−1) value is divided by the N(n, n−1) value to calculate an average footstep of a corresponding interval, and the AP_i value is updated by weighted value calculation with the previously learned AP_i. In this case, a reference character a indicates a weighted value. In addition, the obtained AP_i value is applied as a next average footstep value to calculate a movement distance by the number of steps. In Step S521, n is increased by 1 and learning is repeated in a next interval.

If the position measurement terminal and method according to the embodiment of the invention is used, accurate position measurement becomes possible indoors at low costs without requiring a separate apparatus, which contributes to a field of location measurement in which various application are being developed. If the position measurement terminal and method is applied to a self-controlled mobile robot, it is possible to easily recognize a current location of the robot.

What is claimed is:

1. A position measurement terminal using locations of position identifying tags, the position measurement terminal comprising:
a photographing unit that photographs one of a plurality of position identifying tags including tag identifying information and processes an image of the photographed position identifying tag;
a control and operation unit that performs a control and operation for location measurement of the position measurement terminal; and
a communication unit that has access to a tag position information server that stores position information corresponding to tag identifying information of the individual position identifying tags and receives position information of the position identifying tag.

2. The position measurement terminal of claim 1, further comprising:
a position information storage unit that stores the position information corresponding to the tag identifying information of the individual position identifying tags,
wherein the control and operation unit extracts the position information of the photographed position identifying tag from the position information storage unit.

3. The position measurement terminal of claim 1,
wherein the control and operation unit extracts tag identifying information from the image of the photographed position identifying tag and transmits the extracted tag identifying information to the tag position information server through the communication unit.

4. The position measurement terminal of claim 1,
wherein the control and operation unit calculates the location of the position measurement terminal on the basis of the position information of the position identifying tag, a photographing distance of the position identifying tag, and a photographing angle of the position identifying tag.

5. The position measurement terminal of claim 4, further comprising:
a direction measuring unit that calculates the photographing angle of the position identifying tag.

6. The position measurement terminal of claim 1, further comprising:
a movement distance measuring unit that measures a movement distance of the position measurement terminal; and
a direction measuring unit that measures a movement direction of the position measurement terminal,
wherein the control and operation unit traces the location of the position measurement terminal on the basis of the position information of the position identifying tag, information on a movement distance measured by the movement distance measuring unit, and information on a movement direction measured by the direction measuring unit.

7. The position measurement terminal of claim 6,
wherein the movement distance measuring unit is a pedometer that measures the number of steps of a user.

8. The position measurement terminal of claim 6,
wherein, when a new position identifying tag is photographed and new position information is obtained, the traced location of the position measurement terminal is updated.

9. The position measurement terminal of claim 7,
wherein the control and operation unit updates an average footstep value for each movement speed through learning using actually measured data.

10. A position measurement method using locations of position identifying tags, the position measurement method comprising:
allowing a photographing unit to photograph one of a plurality of position identifying tags including tag identifying information;
allowing a control and operation unit to extract the tag identifying information from the photographed position identifying tag; and
having access to a tag position information server that stores position information corresponding to the tag identifying information to acquire the position information corresponding to the extracted tag identifying information.

11. The position measurement method of claim 10, further comprising:
calculating the location of the position measurement terminal on the basis of the acquired position information in the acquiring of the position information, a photographing distance of the position identifying tag, and a photographing angle of the position identifying tag.

12. The position measurement method of claim 10, further comprising:
tracing the location of the position measurement terminal on the basis of the acquired position information in the acquiring of the position information, information on a movement distance measured by a movement distance measuring unit, and information on a movement direction measured by a direction measuring unit.

13. The position measurement method of claim 12, further comprising:
when position information of a new position identifying tag is acquired in the acquiring of the position information, updating the traced location of the position measurement terminal in the tracing of the location.

14. The position measurement method of claim 12, further comprising:
updating an average footstep value for each movement speed through learning using actually measured data,
wherein the movement distance measuring unit is a pedometer that measures the number of steps.
